(19) United States
(12) Patent Application Publication
(10) Pub. No.: US 2015/0062340 A1
(43) Pub. Date: Mar. 5, 2015

(54) High Occupancy Toll Lane Compliance

(71) Applicant: International Business Machines Corporation, Armonk, NY (US)

(72) Inventors: Ankur Datta, White Plains, NY (US); Rogerio S. Feris, Hartford, CT (US); Sharathchandra Pankanti, Darien, CT (US); Yun Zhai, Bedford Hills, NY (US)

(73) Assignee: International Business Machines Corporation, Armonk, NY (US)

(21) Appl. No.: 14/016,770

(22) Filed: Sep. 3, 2013

(51) Int. Cl. G06K 9/00; H04N 5/225; H04N 5/232; H04N 5/33

(52) U.S. Cl. CPC G06K 9/00838; H04N 5/33; H04N 5/2252; H04N 5/23203
USPC 348/148

(57) ABSTRACT

A method and system for demonstrating compliance with a requirement of a high occupancy lane in a vehicle for a reduced toll charge for the vehicle is provided. The system includes a housing, an infrared camera within the housing, a GPS unit, a transceiver and a control within the housing. The infrared camera images one or more people in the vehicle. The transceiver detects an RF signal indicating that the vehicle is located at or near a toll booth for the high occupancy lane. The control triggers the infrared camera to image the one or more people and transmit a current time, a current location of the vehicle from the GPS unit, and the triggered image of the one or more people, to a server to demonstrate compliance with the requirement of the high occupancy lane for the reduced toll charge for the vehicle.

### FIELD

The present invention relates generally to demonstrating toll lane compliance, and more specifically to a method and associated system for demonstrating compliance with a requirement of a high occupancy lane for a minimum number of passengers in a vehicle for a reduced toll charge for the vehicle.

### BACKGROUND

High occupancy lanes are common on commuter highways. Some high occupancy lanes are limited to vehicles with more than one occupant, and others are open to all vehicles regardless of the number of occupants, but have a reduced toll charge for vehicles with more than one occupant. “EZ Pass” toll systems or other automated toll collection systems are well known where a vehicle has a device mounted inside, and when the vehicle reaches the toll collection station/booth, the device signals the identity of the vehicle to a toll collection transceiver. The toll collection station then automatically charges a credit card account associated with the owner of the vehicle for the toll. However, this identity alone will not indicate whether the vehicle has more than one occupant, and is therefore entitled to a reduced toll charge. An infrared camera system, installed at the toll collection station and aimed at the cabin of the vehicle (as cited in “Infrared Scans May Regulate HOT lanes” and “Infrared cameras to count UK car passengers” in which the camera is mounted at the toll booth, not inside the vehicle), was known to automatically detect the number of occupants within the vehicle. However, this may not always detect all the occupants in the vehicle, especially infants bundled in car seats. Another known technique disclosed in U.S. Pat. No. 7,472,007 uses cameras to classify occupants of a vehicle for restraint system adjustment. However, this classification may not always detect a total number of occupants in the vehicle, especially occupants utilizing independent restraints such as individuals in car seats.

Accordingly, an object of the present invention is to more accurately detect all the occupants within a vehicle, and provide documented proof if needed to challenge an automatic toll charge (received at the end of the month) or a fine for usage of a high occupancy lane by a vehicle that is automatically detected as a low occupancy vehicle.

### SUMMARY

A first aspect of the invention provides a camera system for demonstrating compliance with a requirement of a high occupancy lane for a minimum number of passengers in a vehicle for a reduced toll charge for the vehicle, the camera system comprising: a housing and a mechanism to mount the housing within the vehicle; an infrared camera within the housing to image one or more people other than a driver of the vehicle while the housing is mounted within the vehicle; a GPS unit; a transceiver within the housing to detect an RF signal indicating that the vehicle is located at or near a toll booth for the high occupancy lane; a control within the housing, responsive to detection of the RF signal, to trigger the infrared camera to image the one or more people and transmit (a) a current time, (b) a current location of the vehicle from the GPS unit, and (c) the triggered image of the one or more people, to a server to demonstrate compliance with the requirement of the high occupancy lane for the reduced toll charge for the vehicle.

A second aspect of the invention provides a method for demonstrating compliance with a requirement of a high occupancy lane for a minimum number of passengers in a vehicle for a reduced toll charge for the vehicle, the method comprising: retrieving, by one or more processors, data describing previous locations of a previous driver and one or more previous passengers within an vehicle, wherein the previous locations are described relative to an infra-red camera mounted within the vehicle; determining, by the one or more processors based on the data, a directional position for a field of view of the infra-red camera to encompass the previous locations of the one or more previous passengers within the vehicle; in response to a command from a current driver of the vehicle, triggering the infra-red camera to scan in the directional position within the vehicle; and identifying, by the one or more processors in response to a data stream received from the scan of the infra-red camera, a number of current passengers and a current driver, currently located within the vehicle.

A third aspect of the invention provides a computer program product for demonstrating compliance with a requirement of a high occupancy lane for a minimum number of passengers in a vehicle for a reduced toll charge for the vehicle, the computer program product comprising: one or more computer-readable storage devices and program instructions stored on at least one of the one or more storage devices, the program instructions comprising: program instructions to retrieve data describing previous locations of a previous driver and one or more previous passengers within an vehicle, wherein the previous locations are described relative to an infra-red camera mounted within the vehicle; program instructions to determine based on the data, a directional position for a field of view of the infra-red camera to encompass the previous locations of the one or more previous passengers within the vehicle; in response to a command from a current driver of the vehicle, program instructions to trigger the infra-red camera to scan in the directional position within the vehicle; and in response to a data stream received from the scan of the infra-red camera, program instructions to identify a number of current passengers and a current driver, currently located within the vehicle.

The present invention advantageously provides a simple method and associated system capable of more accurately detecting all occupants within a vehicle and providing documented proof to challenge an automatic toll charge.

### BRIEF DESCRIPTION OF THE DRAWINGS

FIG. 1 illustrates a system for demonstrating compliance with a requirement of a high occupancy lane for a minimum number of passengers in a vehicle for a reduced toll charge for the vehicle, in accordance with embodiments of the present invention.

FIG. 2 illustrates an algorithm detailing a process flow enabled by the system of FIG. 1 for demonstrating compliance with a requirement of a high occupancy lane for a minimum number of passengers in a vehicle for a reduced toll charge for the vehicle, in accordance with embodiments of the present invention.

FIG. 3 illustrates an algorithm detailing a step of the algorithm of FIG. 2, in accordance with embodiments of the present invention.

FIG. 4 illustrates a computer apparatus used by the system of FIG. 1 for demonstrating compliance with a requirement of a high occupancy lane for a minimum number of passengers in a vehicle for a reduced toll charge for the vehicle, in accordance with embodiments of the present invention.

### DETAILED DESCRIPTION OF THE PREFERRED EMBODIMENTS

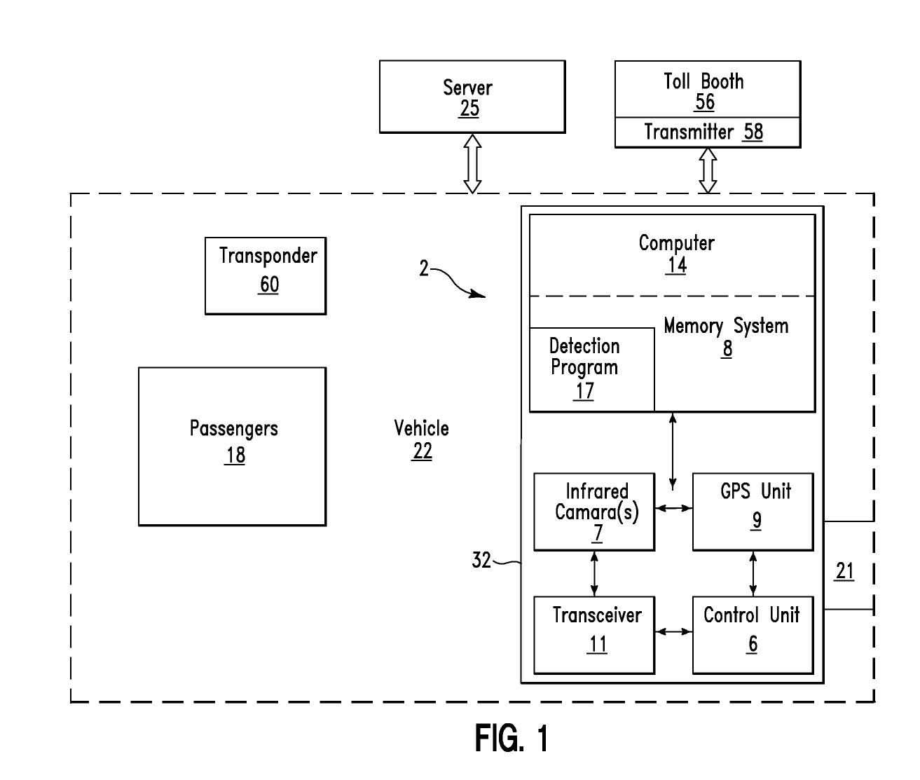

FIG. 1 illustrates a system 2 for demonstrating compliance with a requirement of a high occupancy lane for a minimum number of passengers 18 in a vehicle 22 for legal use of the high occupancy lane or a reduced toll charge for the vehicle 22, in accordance with embodiments of the present invention.

System 2 includes a housing 32, a support mechanism 21 to mount the housing 32 and its contents and attachments within the vehicle 22, and a computer 14, infrared camera 7, global positioning satellite (GPS) unit 9, transceiver 11, and control unit 6 within or attached to the housing 32. For example, support mechanism 21 may include a spring loaded clip, a screw-tightening clamp, a hose clamp, etc. that mechanically connects housing 32 to a rear view mirror within vehicle 22, a headliner within the vehicle 22, a seat within the vehicle 22, etc. Alternatively, housing 32, mechanism 21, infrared camera 7, GPS unit 9, transceiver 11, and/or control unit 6 may be integrated with any interior portion of vehicle 22. The owner of the vehicle 22 may position the support mechanism 21 such that the infrared camera 7 is aimed towards likely locations of passengers in the vehicle 22. For example, if the owner of the vehicle 22 often has an infant in a child seat in the back seat of the vehicle (e.g., where an external camera at toll collection station may visibly detect the child), the owner may position one of the infrared camera(s) 7 to aim toward a normal location of the child seat. This may require mounting of the housing 22 to a location(s) overlooking the back seat.

Computer 14 is communicably connected to (a) infrared camera 7 to receive digital images (taken by infrared camera 7) of passengers within the vehicle 22, (b) GPS unit 9 to receive a GPS location of the vehicle 22, (c) transceiver 11 to receive a signal from transceiver 11 indicating that the vehicle 22 has arrived at a toll collection station, (d) control unit 6 to detect the signal (from transceiver 11) to trigger the infrared camera 7 to image the one or more people, and (e) server 25 to communicate the digital images taken by camera, the GPS location of the vehicle at the time the digital images were taken, a time and date that each image was taken, and an identity of the owner of the vehicle (stored in the computer 14 during registration).

Computer 14 may include any type of computing system(s) including, inter alia, a computer (PC), a laptop computer, a tablet computer, a server, a PDA, a smart phone, a controller, etc. Computer 14 includes a memory system 8 which stores an identification program 17 for identifying human and non-human objects within the vehicle 22. Identification program 17 transmits a result of an analysis and infrared images to the server 25.

Transceiver 11 (i.e., a vehicle-mounted transponder) detects a known RF signal emitted by an known RFID reader/transmitter 58 at a toll collection station/booth 56, for example, to trigger a known E-Z Pass™ transponder 60 that is located in the vehicle and employs the Kapsch data standard to automatically identify the vehicle/owner to electronically pay the toll from the owner's credit or debit card account. The aforementioned RF signal from the RFID reader/transmitter 58 at a toll collection station/booth 56, indicates that vehicle 22 is located at or near a toll booth (i.e., equipped with the E-Z Pass toll collection reader or another RFID toll collection reader such as FasTrak™ reader) for a high occupancy toll lane. The E-Z Pass™ transponder 60 in the vehicle is a type II read/write device that listens for the RF signal broadcast by the RFID reader/transmitter 58 at the toll collection station/booth 56 to determine when to transmit the vehicle/owner identification. The TDM signal of the Kapsch standard is 915 MHz signal sent at 500 kbit/s using the TDM (formerly IAG) protocol in 256 bit packets. The details of the Kapsch standard are available from the Kapsch web site. Thus, the transceiver 11 in vehicle 22 can be activated by the RF signal emitted by the E-Z Pass RFID reader/transmitter 58 at a toll collection station/booth 56. Alternatively, transceiver 11 in vehicle 22 detects and is activated by the transmission from the E-Z Pass transponder 60 in vehicle 22. The transmission from the E-Z Pass transponder 60 is triggered by and responds to the RF signal emitted by the E-Z Pass RFID reader/transmitter 58 at a toll collection station/booth 56. Account information for the vehicle 22 is stored in the transceiver 11. The antenna retrieves the signal, identifies the transceiver 11, and retrieves the account information thereby recording a customer identity, current time and date, and current toll charges. Transceiver 11 recognizes the signal as emanating from the reader/transmitter 58 at a toll collection station/booth 56 based on the account information. Control unit 6 is responsive to detection of the RF signal to trigger the infrared camera to image one or more people and wirelessly transmit to the server 25: an identity of the vehicle and owner of the vehicle as well as a current date/time, the current location of the vehicle from the GPS unit, a triggered image of the one or more people to server 25 (e.g., via a roadside transceiver) and a result of analysis performed by identification program 17 to demonstrate compliance with the requirement of the high occupancy lane for the reduced toll charge for vehicle 22.

### Localizing Relevant Objects

Identification program 17 identifies human and nonhuman objects within vehicle 22 as follows. Identification program 17 determines a background image of the interior of the vehicle from multiple (periodic or user-triggered) images of an unoccupied vehicle. Even though the temperature of the seats and other parts of the vehicle cabin change with ambient temperature and the sun shining through the windows, and affect the intensity of the infrared image, the shape of the seats and the other parts does not change and is detectable from the infrared image.

Identification program 17 identifies the driver using background subtraction and/or pre-determined location specification within a retrieved image (i.e., from infrared camera 7) dependent on a model of vehicle 22 where the infrared camera 7 is mounted to the front rear-view mirror. A field of view (for infrared camera 7) includes at least the front seating area (of vehicle 22) including a driver (i.e., including the driver's face) and front passengers of vehicle 22. Identification program 17 calibrates the field of view such that identification program 17 determines a known region of the driver's face (e.g., an upper right quadrant of an image of the driver). If the drivers face comprises the only heat emitting object in the known region, identification program 17 distinguishes the driver's body, particularly the driver's face, as the main heat emitting source (i.e., identification program 17 captures the drivers face as a thermal reference for detection of passengers in vehicle 22). Identification program 17 extracts specified features of the drivers face (i.e., a facial area) to generate the thermal reference. For example, specified features may include, inter alia, a shape of the facial area, a structure of the facial area, a thermal response of the facial area, etc.

Localization of all driver and non-driver objects may be further classified into human and non-human components. For example, a driver's face, a driver's hand, any portion of the driver's body, inanimate objects such as, inter alia, a hot drink, etc. Identification program 17 has been trained (by the developer of the identification program 17, before installation in the vehicle) to classify heat-emitting objects into human objects (e.g., the driver and passengers of vehicle 22) and non-human objects such as, inter alia, coffee, dogs, cats, hot laptops, etc. In this learning process, the nonhuman objects are placed in a test vehicle and imaged with the infrared camera and the digitized results of the image sent to program 17. Features of any classified non-human objects may be used as negative training sample to improve the performance of identification program 17 (with respect to human detection). Additionally, identification program 17 may comprise an algorithm for learning a distribution of spatial locations of the classified non-human objects (e.g., hot coffee usually resides in a cup holder, dogs usually lay on a seat instead of sitting upright like a human, etc.).

### Extraction of Driver Characteristics

Identification program 17 performs a process for extracting characteristics of the driver (e.g., facial features) using a manual pre-determined facial region or a shape analysis process. For example, extracting characteristics of the driver comprises a progressive fashion process. Initially, computer 14 comprises a set of default feature parameters (e.g., heat response, object movement, prior shape, etc.) to determine a location of the driver's face. The default set of parameters may or may not be accurate in all circumstances (e.g., a facial thermal response may comprise different features during summer months with respect to winter months. In this case, identification program 17 may continuously update feature parameters upon certain detection of a driver's face. For example, identification program 17 may impose a parametric distribution on a selected feature (e.g., fitting a mixture of Gaussian models on thermal responses, fitting shape mesh on a responded facial area over time, etc.). When a new face is detected, its features are used to update the feature distributions. Therefore, system 2 is adaptive to environmental changes.

### Determining a Number of Passengers in Vehicle 22

Identification program 17 performs a process for determining a number of passengers in vehicle 22 by counting a number of regions classified as humans and outputting an associated number. For example, given the structure different vehicles, one or more sensors (i.e., infrared camera(s) 7) may be strategically placed with vehicle 22 to cover all passenger areas. If only a single sensor is necessary, the single sensor will produce a passenger count by scanning its field of view and extracted driver characteristics. Areas comprising high detection responses are classified as valid human faces and a counted number of the areas comprise a passenger count in the vehicle. For privacy purposes, a sensor may be configured such that only a final count is transmitted to an external transceiver (i.e., without any intermediate captured human features). If multiple sensors are necessary to cover all passengers, a front sensor will be defined as a master unit for performing a learning and adaption process with respect to human detection. All additional sensors are considered secondary units thereby receiving human detection parameters from the master unit. The secondary units detect human faces in their respective fields-of-views. Each secondary unit generates a passenger count and all passenger counts are consolidated at the master unit that transmits an overall passenger count to an external transceiver and server 25.

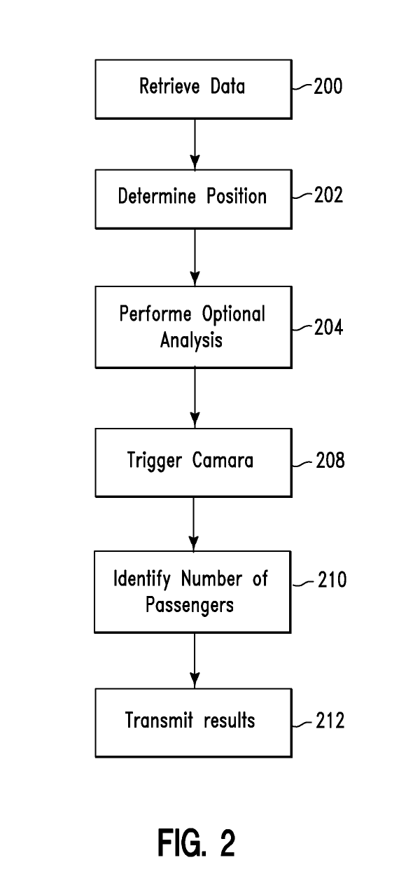

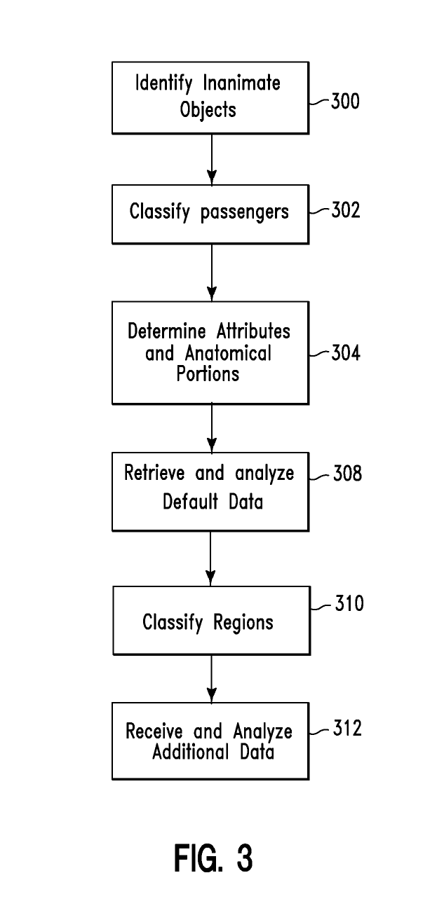

FIG. 2 illustrates the steps performed by the identification program 17 for demonstrating compliance with a requirement of a high occupancy lane for a minimum number of passengers in a vehicle for a reduced toll charge for the vehicle, in accordance with embodiments of the present invention. In step 200, identification program 17 (see FIG. 1) retrieves data describing previous locations of a previous driver and one or more previous passengers within a vehicle (e.g., vehicle 22 in FIG. 1). The previous locations are described relative to an infra-red camera(s) mounted within the vehicle. In step 202, identification program 17 determines (based on the retrieved data of step 200) a directional position for directing a driver to adjust a field of view of the infra-red camera(s) to encompass the previous locations of the one or more previous passengers within the vehicle. The infrared camera may include a digital readout by which identification program 17 continuously reports a number of human occupants detected so that the driver may manually adjust a position of the infrared camera if a missing person is discovered. In step 204, identification program 17 performs an optional analysis process with respect to passenger detection as described in detail with respect to FIG. 3, infra. In step 208 (in response to a command from a current driver of the vehicle), identification program 17 triggers the infra-red camera(s) to scan in determined directional position within the vehicle. In step 210 (in response to a data stream received from the scan of the infra-red camera), identification program 17 identifies (based on results of all previous steps) a number of current passengers and a current driver, currently located within the vehicle by executing steps 200-208. In step 212, computer 14 transmits the number of current passengers (including the current driver) to a system (e.g., server 25) to prove compliance with the high occupancy lane requirements.

FIG. 3 illustrates an algorithm detailing step 204 of FIG. 2 or identification program 17, in accordance with embodiments of the present invention. In step 300, identification program 17 (see FIG. 1) identifies inanimate (and/or non-human) objects located within the vehicle by computing features to distinguish between animate/human and inanimate (and/or non-human). For example, a shape and/or size of a coffee cup or a dog differs from a shape and/or size of a human. Detection program 17 includes a classifier component retreiving features from negative examples (e.g., a coffee cup, a dog, a newspaper, etc) and positive examples (e.g., humans) and using a support vector machine for providing classification. In step 302, identification program 17 classifies the current passengers as animate (or human) objects. In step 304, identification program 17 determines attributes (for geometrically and thermal detecting the previous driver and the previous passengers) and anatomical portions (of the previous driver and the previous passengers). In step 308, identification program 17 retrieves and analyzes the default data describing default feature parameters of a default driver and default passengers. The directional position for the field of view for the infra-red camera is further determined in response to results of the analysis. In step 310, identification program 17 (in response to the results of analyzing the data) classifies regions within the vehicle. A first region includes a region associated with a driver of the vehicle and a group of regions includes regions associated with passengers of the vehicle. In step 312, identification program 17 receives (from a system external to the vehicle) additional data indicating an estimated number of passengers, including a driver, currently located within the vehicle. The number of current passengers is compared to the estimated number of passengers and related results are used to generate the results of step 212 of FIG. 2.

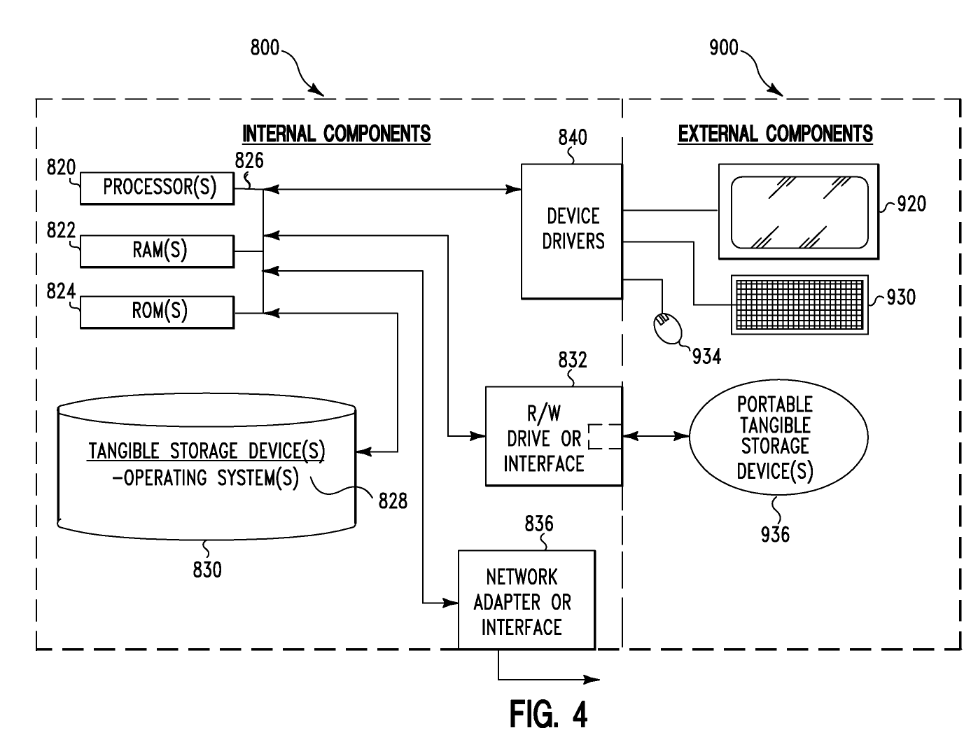

FIG. 4 illustrates a computer apparatus 90 (e.g., computer 14 of FIG. 1) used by system 2 of FIG. 1 for demonstrating compliance with a requirement of a high occupancy lane for a minimum number of passengers in a vehicle for a reduced toll charge for the vehicle or to permit legal use of the high occupancy lane (with or without toll charge), in accordance with embodiments of the present invention. Computer 14 includes a set of internal components 800 and external components 900, illustrated in FIG. 4. The set of internal components 800 includes one or more processors 820, one or more computer-readable RAMs 822 and one or more computer-readable ROMs 824 on one or more buses 826, one or more operating systems 828 and one or more computer-readable storage devices 830. The one or more operating systems 828 and program instructions 17 (for computer 14) are stored on one or more of the respective computer-readable storage devices 830 for execution by one or more of the respective processors 820 via one or more of the respective RAMs 822 (which typically include cache memory). In the illustrated embodiment, each of the computer-readable storage devices 830 is a magnetic disk storage device of an internal hard drive. Alternatively, each of the computer-readable storage devices 830 is a semiconductor storage device such as ROM 824, EPROM, flash memory or any other computer-readable storage device that can store but does not transmit a computer program and digital information.

The set of internal components 800 also includes a R/W drive or interface 832 to read from and write to one or more portable computer-readable storage devices 936 that can store but do not transmit a computer program, such as a CD-ROM, DVD, memory stick, magnetic tape, magnetic disk, optical disk or semiconductor storage device. The program instructions 17 (for computer 14) can be stored on one or more of the respective portable computer-readable storage devices 936, read via the respective R/W drive or interface 832 and loaded into the respective hard drive or semiconductor storage device 830. The term “computer-readable storage device” does not encompass signal propagation media such as copper transmission cables, optical transmission fibers and wireless transmission media.

The set of internal components 800 also includes a network adapter or interface 836 such as a TCP/IP adapter card or wireless communication adapter (such as a 4G wireless communication adapter using OFDMA technology). The programs instructions 17 (for computer 14) can be downloaded to the respective computing/processing devices from an external computer or external storage device via a network (for example, the Internet, a local area network or other, wide area network or wireless network) and network adapter or interface 836. From the network adapter or interface 836, the programs are loaded into the respective hard drive or semiconductor storage device 830. The network may comprise copper wires, optical fibers, wireless transmission, routers, firewalls, switches, gateway computers and/or edge servers.

The set of external components 900 includes a display screen 920, a keyboard or keypad 930, and a computer mouse or touchpad 940. The sets of internal components 800 also includes device drivers 840 to interface to display screen 920 for imaging, to keyboard or keypad 930, to computer mouse or touchpad 940, and/or to display screen for pressure sensing of alphanumeric character entry and user selections. The device drivers 840, R/W drive or interface 832 and network adapter or interface 836 comprise hardware and software (stored in storage device 830 and/or ROM 824).

The programs can be written in various programming languages (such as Java, C+) including low-level, high-level, object-oriented or non object-oriented languages. Alternatively, the functions of the programs can be implemented in whole or in part by computer circuits and other hardware (not shown).

Based on the foregoing, a computer system, method and program product have been disclosed for demonstrating compliance with a requirement of a high occupancy lane for a minimum number of passengers in a vehicle for a reduced toll charge for the vehicle. However, numerous modifications and substitutions can be made without deviating from the scope of the present invention. Therefore, the present invention has been disclosed by way of example and not limitation.

What is claimed is:

1. A camera system for demonstrating compliance with a requirement of a high occupancy lane for a minimum number of passengers in a vehicle, the camera system comprising:
a housing and a mechanism to mount the housing within the vehicle;
an infrared camera within the housing to image one or more people other than a driver of the vehicle while the housing is mounted within the vehicle;
a GPS unit;
a transceiver within the housing to detect an RF signal transmitted at or near a toll booth for the high occupancy lane indicating that the vehicle is located at or near the toll booth for the high occupancy lane;
a control within the housing, responsive to detection of the RF signal, to trigger the infrared camera to image the one or more people and transmit (a) a current time, (b) a current location of the vehicle from the GPS unit, and (c) the triggered image of the one or more people, to a server to demonstrate compliance with the requirement of the high occupancy lane.

2. The camera system of claim 1, further comprising:
an identification program to detect, based on an infrared image from the infrared camera, a number occupants within the vehicle; and
a digital display to indicate the number occupants within the vehicle.

3. The camera system of claim 1, wherein the mechanism is integrated with an interior portion of the vehicle.

4. The camera system of claim 1, wherein the mechanism is attached to an interior portion of the vehicle.

5. The camera system of claim 2, further comprising:
an additional housing and an additional mechanism to mount the additional housing within the vehicle;
an additional infrared camera within the additional housing to image one or more people other than the driver of the vehicle while the additional housing is mounted within the vehicle;
an additional transceiver within the additional housing to detect the RF signal indicating that the vehicle is located at or near the toll booth for the high occupancy lane;
an additional control within the additional housing, responsive to detection of the RF signal, to trigger the additional infrared camera to image the one or more people and transmit (a) the current time, (b) the current location of the vehicle from the GPS unit, and (c) the triggered image of the one or more people, to the server to demonstrate compliance with the requirement of the high occupancy lane for the reduced toll charge for the vehicle; and wherein
the additional mechanism mounts the additional infrared camera to a rear view mirror in the vehicle.

6. The camera system of claim 1, wherein the mechanism mounts the infrared camera to a rear view mirror within the vehicle.

7. The camera system of claim 1, wherein the mechanism mounts the infrared camera to a rear view mirror within the vehicle to image the one or more people while seated in a front seat or a back seat of the vehicle.

8. The camera system of claim 1, wherein the RF signal is transmitted by an RF transmitter located external to the vehicle and mounted at or near the toll booth.

9. The camera system of claim 1, wherein the RF signal is transmitted by a transponder within the vehicle, and wherein the transponder transmits vehicle and/or owner information in response to another RF signal transmitted by a transmitter mounted at or near the toll booth.

10. A method for demonstrating compliance with a requirement of a high occupancy lane for a minimum number of passengers in a vehicle for a reduced toll charge for the vehicle, the method comprising:
retrieving, by one or more processors, data describing previous locations of a previous driver and one or more previous passengers within an vehicle, wherein the previous locations are described relative to an infra-red camera mounted within the vehicle;
determining, by the one or more processors based on the data, a directional position for a field of view of the infra-red camera to encompass the previous locations of the one or more previous passengers within the vehicle;
automatically triggering, by the one or more processors, the infra-red camera to scan in the directional position within the vehicle; and
identifying, by the one or more processors in response to a data stream received from the scan of the infra-red camera, a number of current passengers and a current driver, currently located within the vehicle.

11. The method of claim 10, further comprising:
in response to the data stream received from the infra-red camera, identifying, by the one or more processors inanimate objects located within the vehicle; and
classifying, by the one or more processors, the current passengers as animate objects.

12. The method of claim 10, wherein a spatial location of the current driver defines a reference point for performing the identifying.

13. The method of claim 10, wherein a spatial location of the current driver defines a reference point for thermally detecting said current passengers.

14. The method of claim 10, wherein the analyzing the data comprises:
determining attributes for geometrically and thermal detecting the previous driver and the previous passengers; and
determining based on the attributes, anatomical portions of the previous driver and the previous passengers.

15. The method of claim 10, further comprising:
retrieving, by the one or more processors, default data describing default feature parameters of a default driver and default passengers; and
first analyzing, by the one or more processors, the default data, wherein the directional position for the field of view for the infra-red camera is further determined in response to results of the first analyzing.

16. The method of claim 10, wherein the identifying the number of current passengers comprises detecting facial features of the current passengers.

17. The method of claim 10, further comprising:
in response to the results of the analyzing the data, classifying by the one or more processors regions within the vehicle, wherein a first region of the regions comprises a region associated with a driver of the vehicle, and wherein a group of regions of the regions comprise regions associated with passengers of the vehicle.

18. The method of claim 10, further comprising:
receiving, by the one or more processors from a system external to the vehicle, additional data indicated an estimated number of passengers, including a driver, currently located within the vehicle;
comparing, by the one or more processors, the number of current passengers to the estimated number of passengers; and
transmitting, by the one or more processors to a system for enforcing lane compliance, results of the comparing.

19. A computer program product for demonstrating compliance with a requirement of a high occupancy lane for a minimum number of passengers in a vehicle for a reduced toll charge for the vehicle, the computer program product comprising:
one or more computer-readable storage devices and program instructions stored on at least one of the one or more storage devices, the program instructions comprising:
program instructions to retrieve data describing previous locations of a previous driver and one or more previous passengers within an vehicle, wherein the previous locations are described relative to an infra-red camera mounted within the vehicle;
program instructions to determine based on the data, a directional position for a field of view of the infra-red camera to encompass the previous locations of the one or more previous passengers within the vehicle;
program instructions to automatically trigger the infra-red camera to scan in the directional position within the vehicle; and
in response to a data stream received from the scan of the infra-red camera, program instructions to identify a number of current passengers and a current driver, currently located within the vehicle.

20. The computer program product of claim 19, further comprising:
program instructions stored on at least one of the one or more storage devices, to identify inanimate objects located within the vehicle; and
program instructions stored on at least one of the one or more storage devices, to classify the current passengers as animate objects.
